(19) United States
(12) Patent Application Publication
(10) Pub. No.: US 2017/0300858 A1
(43) Pub. Date: Oct. 19, 2017

(54) METHOD FOR GENERATING AN EVALUATION OF THE ACTIVITIES OF A USER ON A VIRTUAL DOCUMENT

(71) Applicant: PMTP sagl, Tremona-Mendrisio (CH)

(72) Inventors: Alfredo VILLA, Lugano Pregassona (CH); Maurizio CODONI, Tremona-Mendrisio (CH)

(21) Appl. No.: 15/132,725

(22) Filed: Apr. 19, 2016

(51) Int. Cl. G06Q 10/10; G06F 21/62; G06F 17/30; H04L 29/06; H04L 9/06

(52) U.S. Cl. CPC G06Q 10/10; H04L 67/42; H04L 9/0643; G06F 17/30082; G06F 21/6218; G06Q 2220/10

(57) ABSTRACT

A method for generating an evaluation of a user's activities on a virtual document, includes:
(a) providing a server system, having a server memory and server processing unit;
(b) providing an electronic device, having a device memory, device processing unit, elements for connecting with the server system, elements for interacting with and allowing a user to create and modify a virtual document;
   wherein
the device processing unit: (s1) receives information relating the creation or opening of a virtual document; (s2) encrypts the virtual document at subsequent time intervals, to create a plurality of encrypted copies of the virtual documents, each encrypted copy associated with a different time interval; (s3) sends the encrypted copies to the server memory; (s4) interrupts steps (s2) and (s3) when the virtual document is closed;
the server processing unit (s4) compares the encrypted copies; and (s5) generates a report containing the evaluation of the user's activities.

### FIELD OF THE INVENTION

The present invention relates to a method for generating an evaluation of the activities of a user on a virtual document.

Such an evaluation can be useful, among others, e.g. to professional (to prepare a bill or an invoice) or to an employer to monitor the activities of employees, etc. Also it may be used by a generic user to track progress of its own work.

### BACKGROUND OF THE INVENTION

At the present time, this work can be done manually, by means of a user estimation. This may happen a certain time (e.g. days) after performing at least some of the activities carried out on the virtual document. Also, it may be difficult to evaluate the time actually spent on certain kinds of tasks, e.g. the time spent in reviewing a text, or the time spent in actually producing a text, especially when the text is not produced in a single session of work.

Also, this operation is assigned to the user editing the virtual document, with no control on such an operation. As an example, if an employer wants the report of the work done by his employees, he has to trust the word of the employee.

There is thus the need of a method for generating a precise evaluation of the activities of a user on a virtual document. In particular, there is the need of a method for evaluating in detail the work done by a user on a virtual document, which is made in a centralized way.

This and other aims are solved by means of the present invention as claimed in claim 1. Preferred aspects are listed in the dependent claims.

### SUMMARY OF THE INVENTION

According to an aspect, a method for generating an evaluation of the activities of a user on a virtual document carried out by one or more users, comprises the steps of:

(a) providing a server system, having at least a server memory and a server processing unit;

(b) providing an electronic device, provided with a device memory, a device processing unit, means for the connection with the server system, means for interaction with a user, allowing the user to at least create and modify a virtual document;

wherein

(s1) the device processing unit receives information relating the creation or the opening of a virtual document by means of the user;

(s2) the device processing unit encrypts the virtual document at subsequent time intervals, to create a plurality of encrypted copies of the virtual documents, each encrypted copy of the virtual document being associated with a different time interval;

(s3) the device processing unit sends the encrypted copies of the virtual documents to the server memory;

(s4) the device processing unit interrupts steps (s2) and (s3) when the virtual document is closed;

(s5) the server processing unit compares the encrypted copies of the virtual document between one another to evaluate the activities of the user on the virtual document;

(s6) the server processing unit generates a report containing the evaluation of the activities of a user on the virtual document as a function of the comparison of step (s5);

Thanks to the present invention, the data is processed by means of a de-centralized server system, assuring a certain and precise result. Also, the server system guarantees the required computing power to process the data coming from a plurality of users, while the user can continue to normally use their electronic device. Also, encryption allows for security of the data of the user (i.e. the data contained in the virtual document), which is not directly transmitted to the server system.

Also, the above mentioned process does not need any, possibly subjective, evaluation of the user. As a result the report can show an objective, and thus “real”, report about the work done by the user on the virtual document.

According to an aspect, the step (s5) of comparison comprises at least one of: evaluation of the differences between the encrypted copies of the virtual document; evaluation of the length of the encrypted copies of the virtual document; evaluation of repeated words. These parameters may be used to produce a more precise and detailed result during step (s6), i.e. a more precise evaluation.

According to an aspect, the step (s2) of encrypting comprises the steps of:

(s2.1) logically dividing the virtual document into at least one portion;

(s2.2) hashing each portion of the virtual document into a hash code;

(s2.3) creating an encrypted copy of the virtual document containing the hash codes of step (s2.2).

Hashing the document allows typically to reduce the dimension of the encrypted copy with respect to the original document. Thus, the processing (i.e. evaluation) of the hashed content is faster and less resource (i.e. computing power) demanding with respect to the original content (i.e. the original content of the virtual document).

Also, hashing is an operation that is generally not reversible, i.e. it does not allow to revert the hash code into the original document, assuring safety of the data contained in the virtual document. Also, a portion of the hash code may be used to store additional information relating the relevant portion of the virtual document. As an example, a portion of the virtual document may be hashed into a 18 characters hash code (representing the content—generally the text content), and 2 further characters may be used to store information e.g. about the length of the hashed portion, so as to obtain a 20 characters hash code.

According to an aspect, step (s5) of comparison comprises the evaluation of the displacement, addition or deletion of a hash code within the encrypted document.

According to an aspect, before said step (s6), the server processing unit receives further information about the activities of the user on the virtual document from the device dispensing unit. These information may be e.g. the ones that are not derivable from the encrypted copy of the virtual document, e.g. information relating of the time spent by the user on the virtual document, the time spent by the user on the virtual document while writing, the time spent by the user on reviewing the virtual document, etc. This information may be e.g. added to the hash code, or written elsewhere in the encrypted copy, or in an external file on the server, etc.

According to an aspect, the evaluation of the time spent by the user on the virtual document while writing comprises the evaluation of the displacement of words or sentences and/or the evaluation of the text actually written by the user with respect to the text copy-and-pasted from another source.

According to an aspect, the electronic device comprises a screen, and the evaluation of the time spent by the user on reviewing the virtual document comprises the evaluation of the scrolling speed of the virtual document.

According to an aspect, the evaluation of the time spent by the user on reviewing the virtual document comprises the evaluation of the time spent modifying the formatting of the virtual document.

### BRIEF DESCRIPTION OF THE DRAWINGS

With reference to the figure, exemplary and non limiting embodiment will be now discussed, wherein:

FIG. 1 is a schematic view of the server system and of the electronic device for implementing the method according to an embodiment of the present invention.

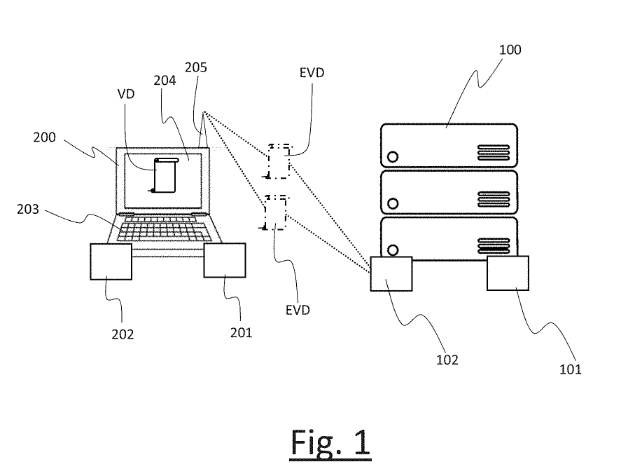

### DETAILED DESCRIPTION OF THE INVENTION

According to an embodiment, a server system 100 comprises at least a server memory 102 and a server processing unit 101. Typically, the server system comprises a pluralities of memories and of processing units. An electronic device 200, having a device processing unit 201 and a device memory 202, allows a user to create and modify a virtual document VD. Typically, the electronic device 200 is a computer. The electronic device 200 (in addition to the means required to the user to interact, e.g. to see and modify, the virtual document, e.g. a keyboard 203 and the screen 204) is provided with means 205 allowing connection with the server system 100. The connection means 205 may be of any kind known, e.g. wired or wireless, that allows to guarantee a connection and an exchange of data between the electronic device 200 and the server system 100.

Both the server system 100 and the electronic device 200 are preferably provided with software to implement one or more aspects of the method here discussed.

When the user creates a virtual document VD (or when he opens an already existing virtual document), the device processing unit 201 set the present method in motion. In particular, the device processing unit 201 may be programmed to start the present method each time a certain application is started on the electronic device 200 (e.g. each time a word processor is opened).

At subsequent time intervals, the device processing unit 201 encrypts the virtual document VD, and creates an encrypted copy of the virtual document EVD (from now on also referred as “encrypted copy EVD”). Each encrypted copy EVD is provided with information relating the time of its creation. Typically, the device processing unit 201 does not encrypt directly the virtual document, but it encrypts the content of the virtual document. As an example, considering a virtual document VD that is a plain text, e.g. a “.txt” file, the encrypted copy EVD may be still a plain text document, e.g. another “.txt” file, where the content of the file has been encrypted. As a result, the “encryption” generally does not restrict the possibility of opening the encrypted copy, but prevents understanding of the content of the encrypted copy. In other words, generally, it is not the file of the encrypted copy EVD that is encrypted, but it is the content of the encrypted copy that is encrypted.

Preferably, the content of the virtual document is hashed into one or more hash codes. The encrypted copy EVD is thus the list of these hash codes. Preferably, the content of the virtual document is logically divided into a plurality of portions, and each portion is hashed into a hash code. As an example, a virtual document containing a text may be logically divided into a plurality of portions, each of the portions corresponding to a paragraph of the text of the virtual document.

The encrypted copies EVD are then sent to the server system 100, that analyzes the differences between the various encrypted copies of the same virtual document, to evaluate the activities of the user of such a virtual document.

As an example, the server system may receive an encrypted copy EVD of a virtual document each 10 minutes. It e.g. receives four encrypted copies EVD1, EVD2, EVD3 and EVD4 of the virtual document VD.

EVD1 contains four hash codes:

kjhs80d87as9yuvioy9876vckjhvf

poiqwebbcuyiuyfahber723b230io

lkjasdfkljwe3897wer234578wdtx

wero87234bsdf769234bkfkw90324

EVD2 contains four hash codes:

kjhs80d87as9yuvioy9876vckjhvf

poiqwebbcuyiuyfahber723b230io

lkjasdfkljwe3897wer234578wdtx

wero87234bsdf769234bkfkw90324

EVD3 contains five has codes:

kjhs80d87as9yuvioy9876vckjhvf

lkjasdfkljwe3897wer234578wdtx

poiqwebbcuyiuyfahber723b230io

wero87234bsdf769234bkfkw90324

894ndig7sm484dmogmwer34ijsd0g

EVD4 contains seven hash codes:

kjhs80d87as9yuvioy9876vckjhvf

rojsng9yeqw4rjksd08rkjwe87ufn

lkjasdfkljwe3897wer234578wdtx

poiqwebbcuyiuyfahber723b230io

wero87234bsdf769234bkfkw90324

894ndig7sm484dmogmwer34ijsd0g

yweruisswdp345897sdmnswdiowqr

When confronting the first two encrypted copies EVD1-EVD2, the server processing unit 101 notices that no amendments were made in the document. Subsequently, from the encrypted copy EVD3, the server processing unit 101 notices that the position of two paragraphs were changed, and that a new paragraph has been added. Finally, from the encrypted copy EVD3, it notices that two further paragraphs have been added to the virtual document VD.

As mentioned, each encrypted copy EVD1-EVD4 is provided with information relating the time of its creation, so that the progress of the activities of the user can be evaluated as a function of time.

Also each portion may be logically divided into sub-portion, and each sub-portion may be hashed independently from the other.

As an example, the hash of the first portion of the virtual document of an encrypted copy may be kjhs80d87as9yuvioy9876vckjhvfa. The hash of the first portion of the virtual document of a subsequent encrypted copy may be kjhs80d87aoeudbqorlo76vckjhvfa. From the comparison of the two encrypted copies, the server processing unit 101 notes not only that the user has amended the first portion of the virtual document, but also that these amendments were carried out only in the central sub-portion of the first portion of the virtual document.

The different encrypted copies need not be in different files. As an example, the copies EVD1-EVD4 may be in a single file, e.g.:

00:00:00

kjhs80d87as9yuvioy9876vckjhvfa

poiqwebbcuyiuyfahber723b230ios

lkjasdfkljwe3897wer234578wdtxk

wero87234bsdf769234bkfkw903241

00:10:00

kjhs80d87as9yuvioy9876vckjhvfa

poiqwebbcuyiuyfahber723b230ios

lkjasdfkljwe3897wer234578wdtxk

wero87234bsdf769234bkfkw903241

00:20:00

kjhs80d87as9yuvioy9876vckjhvfa

lkjasdfkljwe3897wer234578wdtxk

poiqwebbcuyiuyfahber723b230ios

wero87234bsdf769234bkfkw903241

894ndig7sm484dmogmwer34ijsd0gu

00:30:00

kjhs80d87as9yuvioy9876vckjhvfa

rojsng9yeqw4rjksd08rkjwe87ufnt

lkjasdfkljwe3897wer234578wdtxk

poiqwebbcuyiuyfahber723b230ios

wero87234bsdf769234bkfkw903241

894ndig7sm484dmogmwer34ijsd0gu

yweruisswdp345897sdmnswdiowqr6

In this case the content of the virtual document is copied in encrypted (hashed) form after an indication about the time when the document was copied.

Together with the encrypted content of the document, the device processing unit may send to the server further information relating the activities of the user on the virtual document.

As an example, the device processing unit may record the time actually spent by the user on the virtual document. This may be e.g. done by recording the time wherein the virtual document is an active window on the screen of the computer 200. Also the device processing unit may record the time spent by the user on the virtual document while writing. This may be done e.g. by recording the total time spent by the user pressing keys on the computer 200 while editing the virtual document. As a further information, the device processing unit 201 may provide to the server system 100 the evaluation of the time spent by the user on reviewing the virtual document. This may be done e.g. evaluating the time spent on the virtual document without writing, but moving the pointer and/or by evaluating the scrolling speed of the text on the screen of the computer 200.

Also, the device processing unit 201 may record information relating the presence of text (or other elements) of the virtual document that are copy/pasted from another source.

All these information may be inserted within the encrypted copy of the virtual document EVD, or they may be saved elsewhere, e.g. in a separate file on the server.

According to an embodiment, all of part of the additional information on the virtual document VD that are gathered by the device processing unit 201 are inserted within the hash code.

As an example, considering the hash code of a portion of a virtual document (e.g. kjhs80d87as9yuvioy9876vckjhvfa), some characters may be added at the end of the hash code, showing information e.g. about the length of the portion, the time spent by the user for writing the portion, the time spent by the user changing the formatting the portion, the amount of the portion copied by another source. The hash code may e.g. become kjhs80d87as9yuvioy9876vckjhvfajk19i3hju15. From the characters jkl the server processing unit 101 may infer the number of characters of the portion, from the characters 9i3 the server processing unit 101 may infer the number of minutes spent by the user in writing the portion, from the characters hju the server processing unit 101 may infer the minutes spent by the user changing the formatting of the portion, from the characters 15 the server processing unit may infer the percentage of the portion copied from another source. The server processing unit 101 may be provided in a known way with instruction relating how to manage the information within the hash code. The information contained in the hash code may be different from what mentioned, and in general, it can be any information relating the virtual document VD, and/or the activities of the user on the virtual document VD.

Thus, when a user opens (or creates) a virtual document VD on the electronic device 200, the device processing unit 201 start to create encrypted virtual copies EVD of the virtual document VD at different (i.e. subsequent) time intervals. The time intervals may be constant (e.g. an encrypted virtual copy is created every 10 minutes), or it may vary, e.g. according to a pre-determined pattern.

As mentioned, the wording “encrypted” does not imply that the encrypted virtual document (i.e. the electronic file) is encrypted, but it refers to the fact that the content of the encrypted virtual document is encrypted. Also, there may be a different electronic file for each encrypted copy EVD, or they may be stored in a single electronic file.

Each encrypted copy EVD is associated to information relating the time when the encrypted copy EVD was created, i.e. the time when the content of the virtual document has been encrypted and written within the encrypted copy EVD.

The device processing unit 201 stops creating the encrypted virtual copies EVD when the virtual document VD is closed on the electronic device 200.

The device processing unit 201 sends the virtual copies EVD to the server system 100 via the connection means 205 (e.g. via a wired or wireless network), so that they are stored on the server memory 102.

If the connection means 205 can't reach the server system 100, the device processing unit 201 stores the virtual copies EVD in the device memory 202. As soon as the connection between the electronic device 200 and the server system 100 is established, the device processing unit 201 sends the encrypted virtual copies EVD to the server system 100.

Once the server system is provided with the encrypted copies EVD of a virtual document VD, the server processing unit 101 starts processing the encrypted copies, in order to produce a report containing the evaluation of the activities of the user on the virtual document.

In particular, the server processing unit 101 compares the plurality of different copies one with the other, to evaluate the amendments carried out on the virtual document VD as a function of time. Furthermore, the additional information relating the virtual document VD and/or the activities of the user on the virtual document provided by the device processing unit 201 to the server processing unit 101 is evaluated in this step. As mentioned, this information may be e.g. one or more of: the time spent by the user on the virtual document, the time spent by the user on the virtual document while writing, the time spent by the user on reviewing the virtual document, information about the use of material (e.g. text) from another source, etc.

The processing of all this data is carried out by the server processing unit 101, which typically has a greater computing power with respect to the device processing unit 201.

As mentioned, the report is generated as a function of objective parameters, that are not affected by the perception of the user. As a result, the report can show a realistic and certified representation of the work done by the user.

It is noted that particular reference was made to a virtual document containing only text. The present method may be applied as well to virtual document containing other kinds of material in addition (or replacement) of text. The hash function may be in principle applied to any kind of content. As an example, a virtual document may contain three paragraphs of text and an image. The three paragraph may be e.g. hashed as three different portions of the virtual document, while the image may be hashed as the fourth portion of the virtual document.

1) A method for generating an evaluation of the activities of a user on a virtual document carried out by a user, comprising the steps of:
(a) providing a server system, having at least a server memory and a server processing unit;
(b) providing an electronic device, provided with a device memory, a device processing unit, means for the connection with the server system, means for interaction with a user, allowing the user to at least create and modify a virtual document;
wherein
(s1) the device processing unit receives information relating the creation or the opening of a virtual document by means of the user;
(s2) the device processing unit encrypts the virtual document at subsequent time intervals, to create a plurality of encrypted copies of the virtual documents, each encrypted copy of the virtual document being associated with a different time interval;
(s3) the device processing unit sends the encrypted copies of the virtual documents to the server memory;
(s4) the device processing unit interrupts steps (s2) and (s3) when the virtual document is closed;
(s5) the server processing unit compares the encrypted copies of the virtual document between one another to evaluate the activities of the user on the virtual document;
(s6) the server processing unit generates a report containing the evaluation of the activities of a user on the virtual document as a function of the comparison of step (s5).

2) The method according to claim 1, wherein said step (s5) of comparison comprises at least one of:
evaluation of the differences between the encrypted copies of the virtual document;
evaluation of the length of the encrypted copies of the virtual document;
evaluation of repeated words.

3) The method according to claim 1, wherein said step (s2) of encrypting comprises the steps of:
(s2.1) logically dividing the virtual document into at least one portion;
(s2.2) hashing each portion of the virtual document into a hash code;
(s2.3) creating an encrypted copy of the virtual document containing the hash codes of step (s2.2).

4) The method of claim 3, wherein said step (s5) of comparison comprises the evaluation of the displacement, addition or deletion of a hash code within the encrypted document.

5) The method of claim 3, wherein each of the portion of the virtual document is further logically divided into a plurality of sub-portion, each sub-portion being hashed independently from the other.

6) The method of claim 1, wherein before said step (s6), the server processing unit receives further information about the activities of the user on the virtual document from the device dispensing unit.

7) The method of claim 6, wherein said further information comprises at least one of:
evaluation of the time spent by the user on the virtual document;
evaluation of the time spent by the user on the virtual document while writing;
evaluation of the time spent by the user on reviewing the virtual document.

8) The method of claim 7, wherein the evaluation of the time spent by the user on the virtual document while writing comprises the evaluation of the displacement of words or sentences and/or the evaluation of the text actually written by the user with respect to the text copy-and-pasted from another source.

9) The method of claim 8, wherein the electronic device comprises a screen, and the evaluation of the time spent by the user on reviewing the virtual document comprises the evaluation of the scrolling speed of the virtual document.

10) The method of claim 7, wherein the evaluation of the time spent by the user on reviewing the virtual document comprises the evaluation of the time spent modifying the formatting of the virtual document.
